(19) United States
(12) Patent Application Publication
(10) Pub. No.: US 2008/0048125 A1
(43) Pub. Date: Feb. 28, 2008

(54) Convertible radiation beam analyzer system

(76) Inventor: Daniel Navarro, Port St. Lucie, FL (US)

Correspondence Address: MCHALE & SLAVIN, P.A., 2855 PGA BLVD, PALM BEACH GARDENS, FL, 33410, US

(21) Appl. No.: 11/510,275

(22) Filed: Aug. 25, 2006

(51) Int. Cl. H01J 47/00; G01T 1/185

(52) U.S. Cl. 250/389

(57) ABSTRACT

The instant invention relates a convertible radiation beam analyzer for measuring the distribution and intensity of radiation produced by a radiation source. More specifically, the instant invention is a convertible radiation scanning device that includes a single guideway module constructed and arranged for attachment to dynamic phantom tank in various orientations for traversing a radiation detection probe through a radiation beam along various axes to determine radiation intensity and distribution throughout the beam.

### RELATED APPLICATIONS

This application is related to U.S. Pat. No. 6,225,622 as well as U.S. patent application Ser. No. 11/427,197 entitled Modular Radiation Beam Analyzer, the contents of which are incorporated herein by reference.

### FIELD OF THE INVENTION

This invention relates to a device and system for measuring the intensity and distribution of a radiation beam produced by a linear accelerator or other radiation producing device, and particularly relates to a device and system which includes a single guideway convertible to move a radiation detector along a depth plane or a cross plane, and a kit for converting pre-existing single plane radiation beam analyzers to multi-plane radiation beam analyzers.

### BACKGROUND OF THE INVENTION

Various well-known medical techniques for the treatment of malignancies involve the use of radiation. Radiation sources, for example medical linear accelerators, are typically used to generate radiation to a specific target area of a patient's body. Use of appropriate dosimetry insures the application of proper doses of radiation to the malignant areas and is of utmost importance. When applied, the radiation produces an ionizing effect on the malignant tissue, thereby destroying the malignant cells. So long as the dosimetry of applied radiation is properly monitored, the malignancy may be treated without detriment to the surrounding healthy tissue. Accelerators may be utilized, each of which have varying characteristics and output levels. The most common type of accelerator produces pulse radiation, wherein the output has the shape of a rectangular beam with a cross-sectional area which is typically between 16 and 1600 square centimeters. Rectangular or square shapes are often changed to any desired shape using molded or cast radiation shielding materials such as lead or cerrobend. While some accelerators are continuous or non-pulsed such as cobalt radiation machines, other more advanced accelerators use multi-leaf collimators. Still other accelerators sweep a very narrow electron beam across the treatment field by means of varying electromagnetic fields.

To ensure proper dosimetry, linear accelerators used for the treatment of malignancies must be calibrated. Both the electron and photon radiation must be appropriately measured and correlated to the particular device. The skilled practitioner must insure that both the intensity and duration of the radiation treatment is carefully calculated and administered so as to produce the therapeutic result desired while maintaining the safety of the patient. Parameters such as flatness, symmetry, radiation and light field alignment are typically determined. The use of too much radiation may, in fact, cause side effects and allow destructive effects to occur to the surrounding tissue. Use of an insufficient amount of radiation will not deliver a dose that is effective to eradicate the malignancy. Thus, it is important to be able to determine the exact amount of radiation that will be produced by a particular machine and the manner in which that radiation will be distributed within the patient's body.

In order to produce an accurate assessment of the radiation received by the patient, at the target area, some type of pattern or map of the radiation at varying positions within the patient's body must be produced. These profiles correlate 1) the variation of dose with depth in water generating percent depth dose profiles and 2) the variation of dose across a plane perpendicular to the radiation source generating the cross beam profiles. These measurements of cross beam profiles are of particular concern in the present invention. Although useful for other analyses, the variation of the beam uniformity within the three dimensional radiation field is the main purpose of this device.

There are companies that provide calibration service to hospitals and treatment centers. These technicians must visit the facility and conduct the calibration of the radiation source with their own equipment. This requires lightweight, easily portable, less cumbersome radiation measuring devices that can be quickly assembled and disassembled on site. The actual scanning should also be expeditious with the results available within a short time frame. Such equipment allows a technician to be more efficient and calibrate more radiation devices in a shorter period of time.

One existing system for measuring the radiation that is produced by medical linear accelerators utilizes a large tank, on the order of 50×50×50 cm, filled with water. A group of computer controlled motors move the radiation detector through a series of pre-programmed steps along a single vertical axis beneath the water's surface. Since the density of the human body closely approximates that of water, the water-filled tank provides an appropriate medium for creating a simulation of both the distribution and the intensity of radiation which would likely occur at various depths within the patient's body. The aforementioned tank is commonly referred to as a water phantom. The radiation produced by the linear accelerator will be directed into the water in the phantom tank, at which point the intensity of the radiation at varying depths and positions within the water can be measured with the radiation detector. As the radiation penetrates the water, the direct or primary beam is scattered by the water, in much the same way as a radiation beam impinging upon the human patient. Both the scattered radiation as well as the primary radiation are detected by the ion-chamber, which is part of the radiation detector.

The ion-chamber is essentially an open air capacitor which produces an electrical current that corresponds to the number of ions produced within its volume. The detector is lowered to a measurement point within the phantom tank and measurements are taken over a particular time period. The detector can then be moved to another measurement point where measurements are taken as the detector is held in the second position. At each measuring point a statistically significant number of samples are taken while the detector is held stationary.

### DESCRIPTION OF THE PRIOR ART

Several prior art devices are known to teach systems for ascertaining the suitable dosimetry of a particular accelerator along with methods for their use.

U.S. Pat. Nos. 5,621,214 and 5,627,367, to Sofield, are directed to a radiation beam scanner system which employs a peak detection methodology. The device includes a single axis mounted within a water phantom. In use, the water phantom must be leveled and a reference detector remains stationary at some point within the beam while the signal detector is moved up and down along the single axis by the use of electrical stepper motors.

U.S. Patent Application Publication 2006/0033044 A1, to Gentry et al., is directed to a treatment planning tool for multi-energy electron beam radiotherapy. The system consists of a stand-alone calculator that enables multi-energy electron beam treatments with standard single electron beam radio-therapy equipment thereby providing improved dose profiles. By employing user defined depth-dose profiles, the calculator may work with a wide variety of existing standard electron beam radiotherapy systems.

U.S. Pat. No. 6,225,622, issued May 1, 2001 to Navarro, the inventor here, describes a dynamic radiation measuring device that moves the ion chamber through a stationary radiation beam to gather readings of radiation intensity at various points within the area of the beam. The disclosure of this patent is incorporated herein, by reference.

While these devices employ a water phantom, they are limited to moving the signal detector along the single vertical axis and can only provide a depth scan of the beam.

U.S. Pat. No. 4,988,866, issued Jan. 29, 1991, to Westerlund, is directed toward a measuring device for checking radiation fields from treatment machines used for radiotherapy. This device comprises a measuring block that contains radiation detectors arranged beneath a cover plate, and is provided with field marking lines and an energy filter. The detectors are connected to a read-out unit for signal processing and presentation of measurement values. The dose monitoring calibration detectors are fixed in a particular geometric pattern to determine homogeneity of the radiation field. In use, the measuring device is able to check the totality of radiation emitted by a single source of radiation at stationary positions within the measuring block.

U.S. Patent Application Publication 2005/0173648 A1, to Schmidt et al., is directed to a wire free, dual mode calibration instrument for high energy therapeutic radiation. The apparatus includes a housing with opposed first and second faces holding a set of detectors between the first and second faces. A first calibrating material for electrons is positioned to intercept electrons passing through the first face to the detectors, and a second calibrating material for photons is positioned to intercept photons passing through the second face to those detectors.

These devices do not use a water phantom and are additionally limited in that all of the ionization detectors are in one plane. This does not yield an appropriate three-dimensional assessment of the combination of scattering and direct radiation which would normally impinge the human body undergoing radiation treatment. Thus, accurate dosimetry in a real-life scenario could not be readily ascertained by the use of these devices.

U.S. Pat. No. 5,006,714, issued Apr. 9, 1991, to Attix utilizes a particular type of scintillator dosimetry probe which does not measure radiation directly, but instead measures the proportional light output of a radiation source. The probe is set into a polymer material that approximates water or muscle tissue in atomic number and electron density. Attix indicates that the use of such a detector minimizes perturbations in a phantom water tank.

Additionally, there is an apparatus called a Wellhofer bottle-ship which utilizes a smaller volume of water than the conventional water phantom. The Wellhofer device utilizes a timing belt and motor combination to move the detector, thus requiring a long initial set-up time.

Thus, there exists a need for a convertible radiation beam analyzer device and system. The device should be portable and capable of being quickly assembled for use and disassembled for transport. The device should also be capable of repeated, accurate detection of both scattering and direct radiation components from radiation devices. The system should include a single guideway module that is convertible to move a radiation detector along at least one vertical and at least one horizontal axis to result in three dimensional scans of radiation beams.

### SUMMARY OF THE INVENTION

The instant invention is a convertible radiation beam analyzer for measuring the distribution and intensity of radiation produced by a radiation source. More specifically, the instant invention is a radiation scanning device that includes a single guideway module that is constructed to be secured within a water phantom tank in various orientations for precision depth and cross field radiation scans. The single guideway is constructed and arranged to traverse a radiation detector along its length at various user specified speeds while simultaneously taking measurements within the radiation field. Also disclosed is a kit for expanding the capabilities of pre-existing single vertical axis radiation scanning devices. The kit cooperates with the guideway module of the pre-existing devices to allow them to be secured to the water phantom at various orientations so that the devices may be utilized for both depth and cross scans of radiation fields.

The present invention is based upon the general principle of scanning a simulated target area of radiation by the use of a radiation detector attached to a moving platform to develop a one, two or three dimensional plot of the dosage delivered. The modular apparatus of this invention may be used in a water phantom or with solid water slabs or wafers simulating that portion of the target area which affects the radiation beam.

In one embodiment, the instant invention translates the radiation detector in a water phantom. The use of the water phantom results in the scattering of the directly applied radiation in the water tank in a manner similar to that which occurs when this direct radiation impinges upon the human body being treated. In another embodiment, the guideway module is utilized to translate a dynamic phantom utilizing the tank as a mounting surface for supporting the module in the desired orientation.

One characteristic of the invention is the over-all speed of the process of producing a plot of radiation dosage; eg., this apparatus may be assembled, converted to measure a second axis and disassembled in less than 5 minutes. The single guideway is constructed and arranged for multi-position attachment to a phantom tank with thumb screws for ease and speed of assembly. When mounted for cross-scanning of radiation beams the guideway may be leveled manually using only one leveling screw.

The controller utilized with the instant invention is preferably incorporated directly into the guideway module to allow direct connection to a hand pendant or computer for controlling movement of the radiation detector. The integral controller permits incremental and/or continuous movement of the radiation detector throughout the predetermined scanning field. The device is constructed to allow up to about 42000 radiation samples to be taken for every “step” of movement. The size of the step can be changed electronically from 0.01 millimeter to 1 millimeter depending upon the desired scan accuracy, and the device is capable of taking measurements during continuous movement of the radiation detector. The field of scan may be input manually by utilizing the hand pendant, or the field of scan may be programmed into the computer and thereafter the scan is completed automatically. The results of the scan can be read directly through the pendant, or they may be output graphically to a computer monitor or a printing device.

Accordingly, it is a primary objective of the instant invention to provide a radiation detection and measurement device which includes a single guideway convertible to take both depth and cross field measurements.

It is another objective of the instant invention to provide a kit for converting a single axis radiation measuring device into a multi-axis radiation measuring device.

It is yet another objective of the instant invention to provide a guideway having a single leveling point to level the guideway with respect to the phantom tank water surface.

It is a further objective of the instant invention to provide a guideway having a stepper motor with an integral controller for direct connection to a computer or hand pendant.

It is yet a further objective of the instant invention to provide a system having a guideway convertible to traverse a dynamic phantom through a radiation beam throughout at least two distinct axes for radiation measurement.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a front perspective view of one embodiment of the instant invention illustrating the module in a vertical orientation;

FIG. 2 is a front view illustrating operation of the embodiment shown in FIG. 1;

FIG. 3 is a left perspective view of one embodiment the instant invention;

FIG. 4 is a rear perspective view of one embodiment of the instant invention;

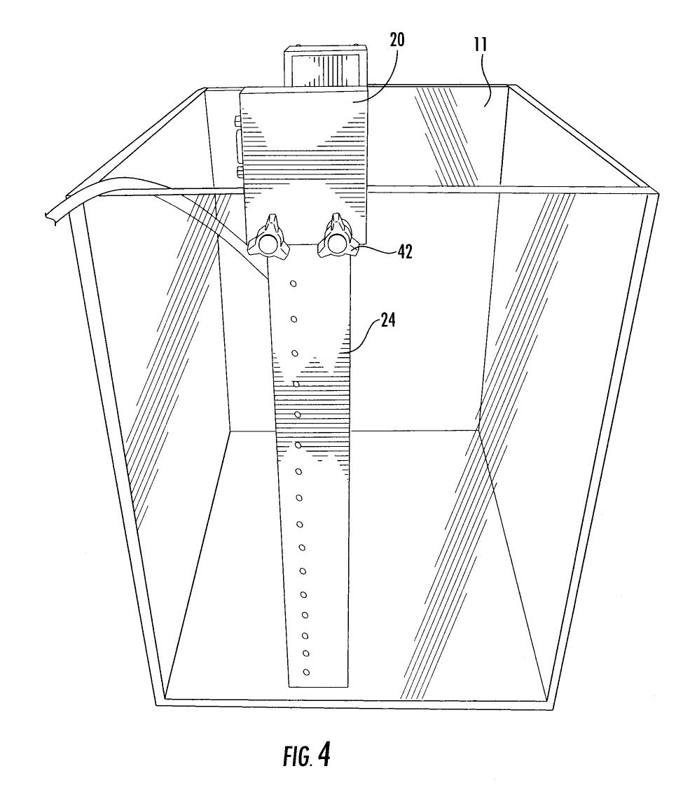

FIG. 5 is a partial front perspective view of one embodiment of the instant invention, illustrating the module in a horizontal orientation;

FIG. 6 is a rear view of the embodiment shown in FIG. 5;

FIG. 7 is a plan view of the leveling assembly utilized with the instant invention;

FIG. 8 is a front view of one embodiment of the module utilized with the instant invention;

FIG. 9 is a right side view of one embodiment of the module utilized with the instant invention;

FIG. 10 is graph of an output from the instant invention illustrating density and distribution of radiation produced by a depth scan;

FIG. 11 is graph of an output from the instant invention illustrating density and distribution of radiation produced by a cross profile scan;

FIG. 12 is a front perspective view of one embodiment of the instant invention illustrated in combination with a computer.

FIG. 13 is a side perspective view of one embodiment of the instant invention illustrated in combination with a dynamic phantom.

### DETAILED DESCRIPTION OF THE INVENTION

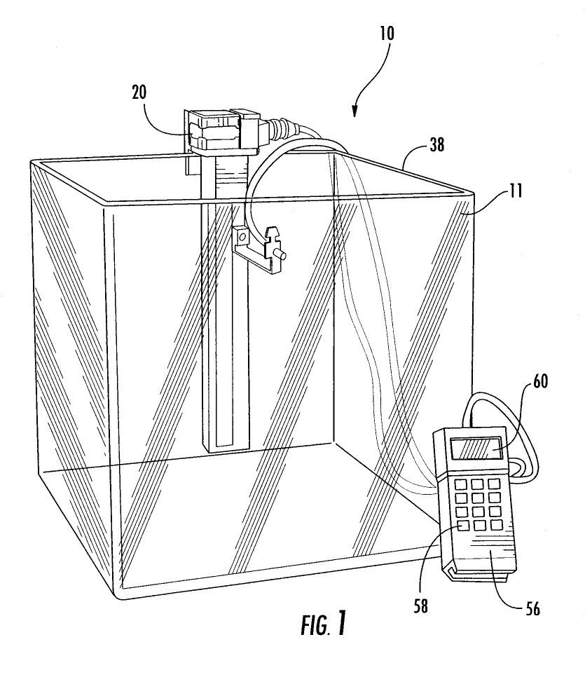

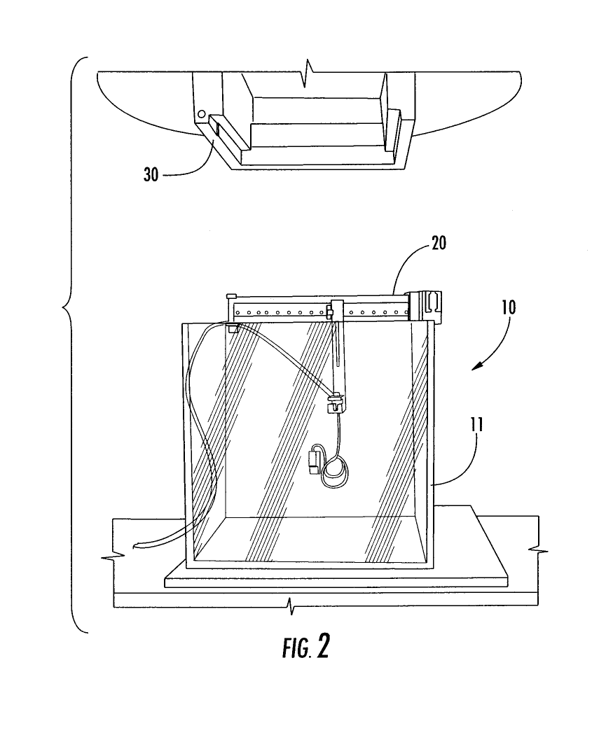

Referring generally to the Figures, the convertible radiation beam analyzer 10 for measuring the distribution and intensity of radiation produced by a radiation source 30 is illustrated. The radiation source is generally utilized for medical treatment and may be a linear accelerator or, alternatively, a cobalt machine as is well known in the art. The radiation beam analyzer 10 generally includes a phantom tank 11 constructed and arranged to contain a material having a density approximating that of a human body. In general, the phantom tank is sized to accommodate a single module 20 positionable in a vertical orientation as shown in FIG. 1 and a horizontal orientation as shown in FIG. 2. In a most preferred embodiment, the width of one side of the tank will be substantially the same as the depth to permit full travel of the carriage 22 along the length of the guideway 24 while the module is secured in either position. The base and walls of the tank may be constructed of acrylic, polycarbonate or other suitable non-metallic materials well known in the art. When filled with water, the tank 11 serves as a water phantom simulating the body of a patient undergoing radiation treatment. The convertible module is constructed and arranged to fit neatly within a carrying case (not shown) for ease of transport, whereby the module and phantom tank may be quickly assembled together at a desired location and radiation measurements may be quickly taken with the desired assembly configuration.

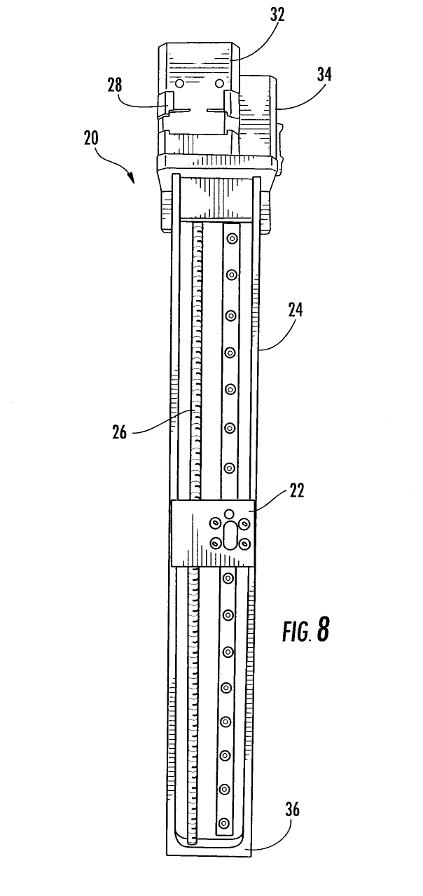

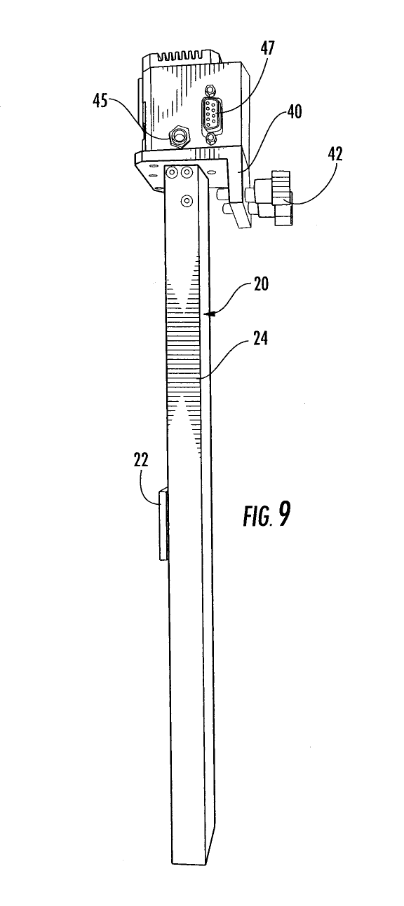

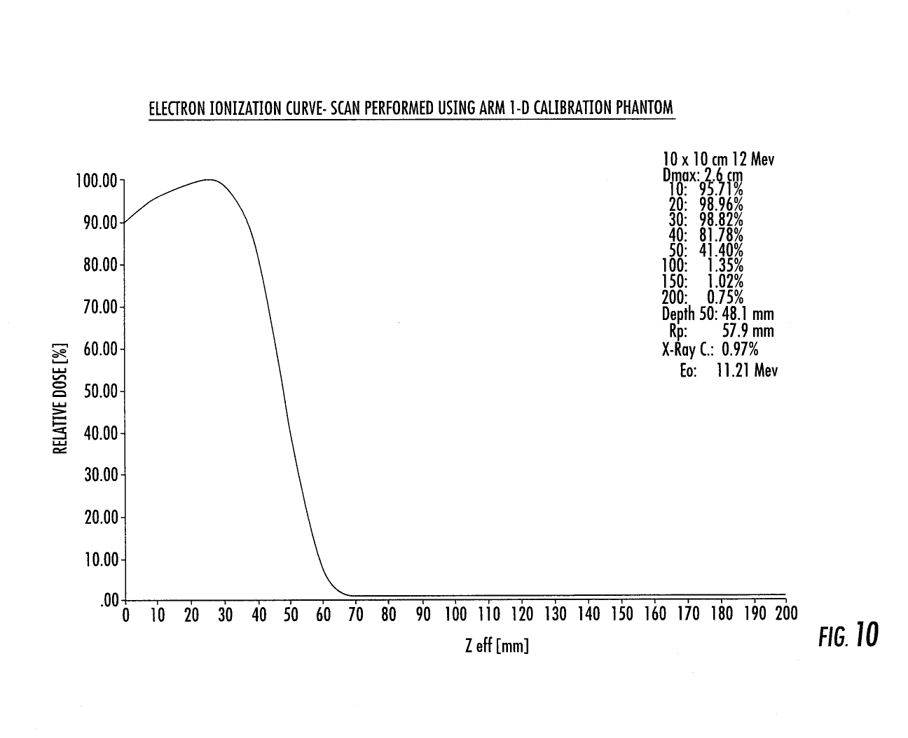

Referring to FIGS. 8-9, the module 20 includes a guideway 24 having a first end 34 and a second end 36. The length of the guideway is sufficient to extend substantially across an upper portion of the phantom tank 11 as well as the depth of the tank wherein the tank is sized to accommodate the radiation beam being measured. In a most preferred embodiment the tank is about 30 cm square, however larger or smaller tanks may be utilized without departing from the scope of the invention. The first end of the guideway includes a power connector 45 and a bi-directional connector 47. The bi-directional connector is constructed and arranged to cooperate with the hand pendant 56 (FIG. 1) or a computer for control of the module. In a most preferred embodiment the bi-directional connector is an RS-232 connector, however other suitable connectors capable of bi-directional communication with an auxiliary device may be utilized without departing from the scope of the invention. The first end of the guideway is constructed and arranged to include a U-shaped portion 40 to straddle cooperate an upper perimeter 38 (FIG. 1) of the phantom tank 11. The U-shaped portion includes at least one thumb screw 42, positioned to cooperate with a side surface of the phantom tank to secure the module in a substantially vertical orientation defining a first mounting position. The U-shaped portion is constructed to cooperate with any of the tank side-walls to maintain the desired vertical orientation of the module with respect to the tank. In the vertical orientation the instant invention may be utilized to perform depth scans of the radiation beam to provide an output such as that shown in FIG. 10.

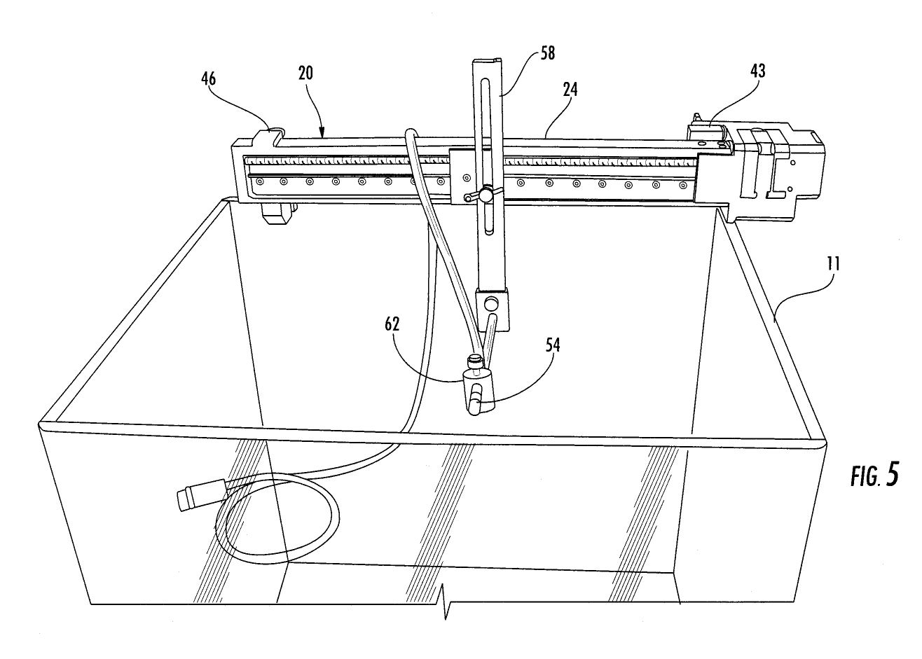

Referring to FIGS. 2, 5 and 6 the module 20 is illustrated in the second mounting position for performing cross scans of radiation fields. In this embodiment, the tank is provided with a removable vertical member 43 securable to a side wall and/or upper perimeter of the tank and extending upwardly with respect thereto. The vertical member is adapted for attachment to the phantom tank with a suitable fastener 44 whereby the vertical member may be removed for transport or storage of the phantom tank. The vertical member is sized to cooperate with the U-shaped portion of the module guideway to support the module guideway in a substantially horizontal orientation. In this manner, the same thumb screws can be utilized to secure the module to the tank in either configuration. For stability the vertical member may be provided with a relieved step 49 that is constructed and arranged to cooperate with the upper perimeter of the tank.

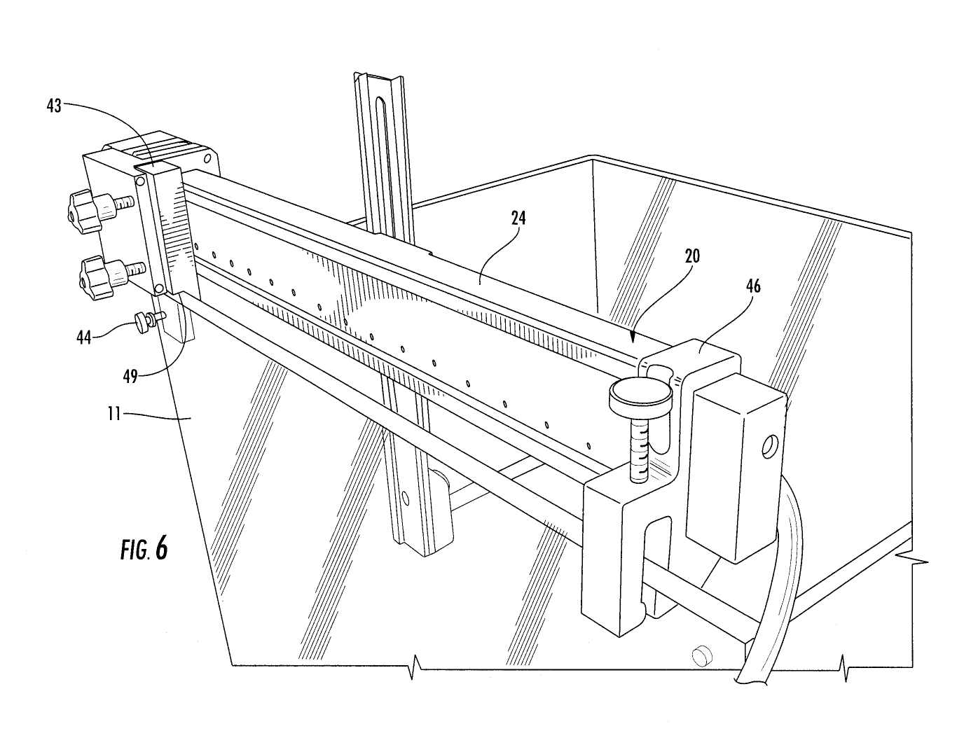

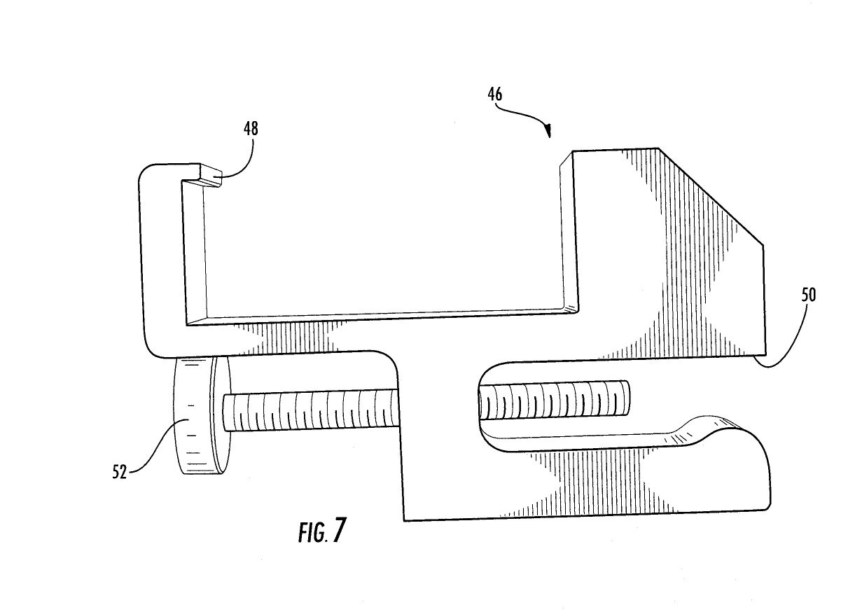

Referring to FIGS. 6 and 7, the leveling assembly 46 is illustrated. The leveling assembly is constructed and arranged to removably cooperate with the second end of the module as well as the upper perimeter of the phantom tank for manual leveling of said guideway. The leveling assembly includes a C-shaped portion 48 constructed and arranged to cooperate with the second end of the module in an overlapping fashion and a U-shaped portion 50 having at least one threaded member 52 for cooperation with the upper perimeter of the phantom tank, whereby manual rotation of the threaded member causes the second end of the module guideway to move up or down with respect to the upper perimeter of the phantom tank.

Referring to FIGS. 8 and 9, the guideway includes a carriage 22 slidably secured to the guideway for controlled movement along the length thereof. In the preferred embodiment, the guideway 24 includes a lead screw 26 rotatably mounted thereon. The lead screw 26 is operably connected to the carriage 22 to provide linear motion thereto during rotation of the lead screw. A first stepper motor 28 is operably connected to the first lead screw for controlled bi-directional rotation thereof. In one embodiment the stepper motor is connected to the first lead screw via a geared timing belt (not shown). Alternatively, the stepper motor could be connected to the first lead screw with gears, chains, cables, direct connection or suitable combinations thereof without departing from the scope of the invention. The stepper motor 28 is in electrical communication with the controller 32 to receive electrical commands therefrom, and if needed to provide feedback thereto. The module is preferably constructed of aluminum having a hard anodized surface for oxidation control, wear properties and appearance. However, it should be noted that other materials well known in the art suitable for construction of the guideway, carriage and lead screws could be utilized without departing from the scope of the invention. Such materials may include, but should not be limited to, metals, plastics, composites and suitable combinations thereof. It should also be noted that while stepper motor(s) are the preferred embodiment for rotation of the lead screw, other electrical motors such as servo motors and the like, suitable for providing smooth controlled rotation and/or feedback to the controller, may be utilized without departing from the scope of the invention.

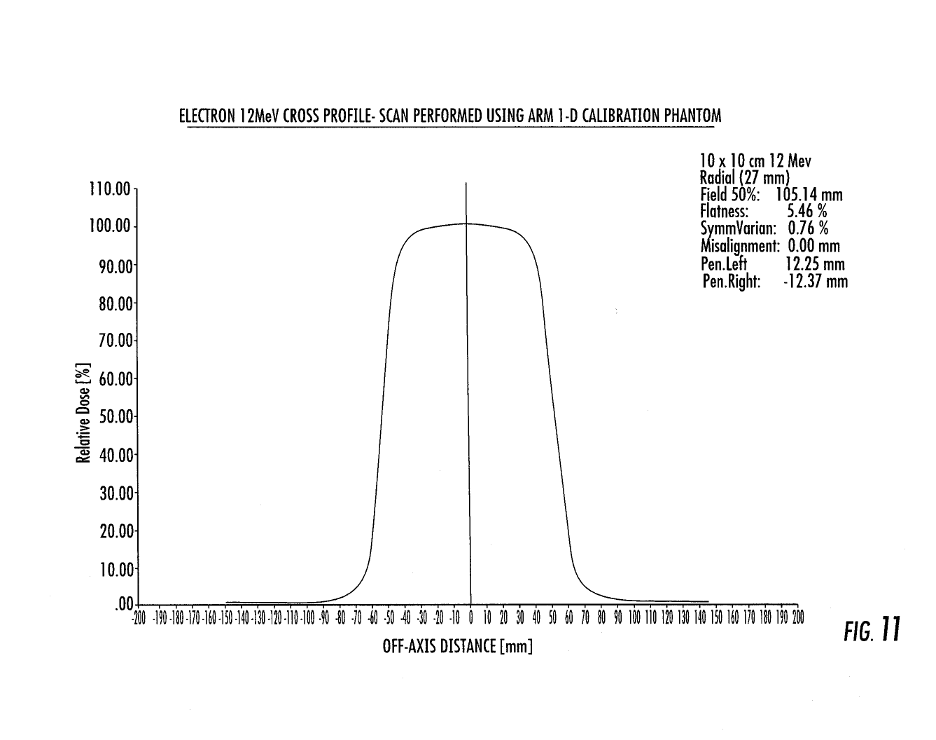

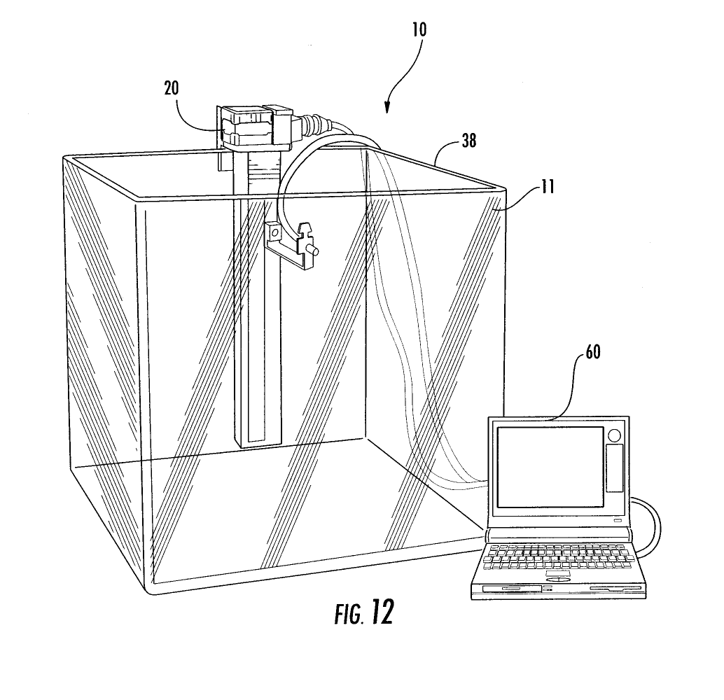

Referring to FIG. 1, the radiation beam analyzer 10 is illustrated. In this embodiment, the controller is connected to a hand pendant 56 having at least one manually operable member 58, e.g. switch, for instructing an input of a desired direction for manually controlled movement of the carriage. The hand pendant also includes a display 60 for displaying commands, and thereafter the results, of a scan. Within the preferred embodiment, the hand pendant includes a computer for operational control of the carriage movements, whereby the computer is constructed and arranged to accept commands from an operator, via keypad or button operation, to cause movement of the radiation detection probe under computer control throughout a predetermined field within the phantom tank. As an alternative embodiment, the controller may be connected directly to a laptop or desktop computer 60 (FIG. 12) having suitable software for input of commands to the controller. In response to the radiation measurements taken, the computer is constructed and arranged to produce a graphical representation FIGS. 10 and 11 of the recorded density and distribution of the radiation beam associated with the scan.

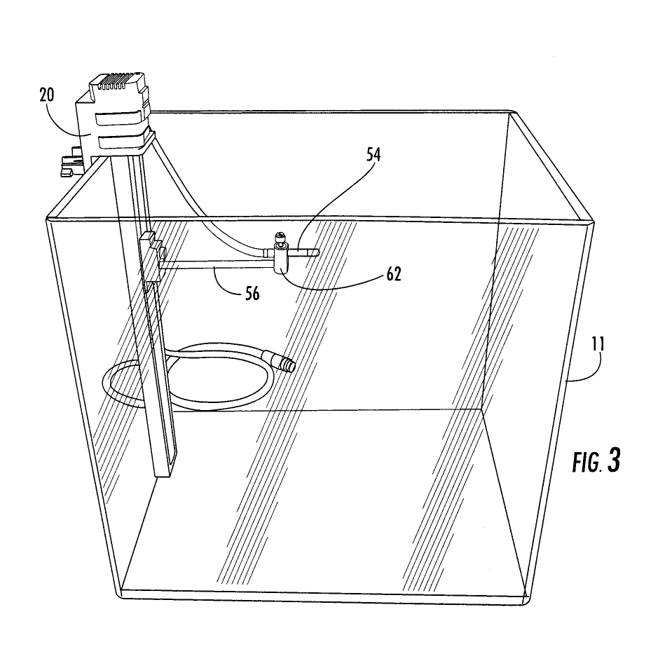

Referring to FIGS. 1-3, the radiation detection probe 54 is preferably an ion chamber however, it should be noted that other suitable radiation detection probes such as, but not limited to, diodes and the like may be utilized without departing from the scope of the invention. The radiation detection probe is electrically connected to the hand pendant or computer, as is well known in the art. The detection probe, e.g. ion chamber, 54 is secured to the carriage via a beam member 56 which is preferably straight for depth scans as shown in FIGS. 1 and 3. Alternatively, the beam member may be L-shaped 58, wherein one leg of the L-shaped beam is secured to the carriage and the other leg of the L-shaped beam is utilized to lower the ion chamber into the tank as shown in FIGS. 2, 5 and 6. In either embodiment, the beams 56, 58 are provided with a moveable clamp member 62. The clamp member is constructed and arranged to permit the ion chamber to be infinitely positionable along the beam member for various cross scan patterns.

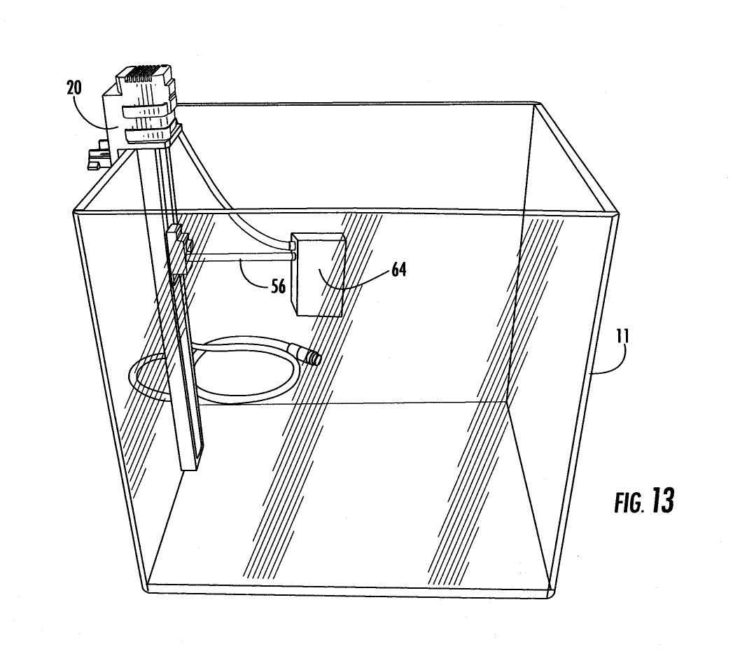

Referring to FIG. 13, an alternative method of utilizing the module in combination with a dynamic phantom 64 is illustrated. In this embodiment the dynamic phantom 64 is secured to the carriage 22 for movement therewith. In operation, the dynamic phantom is moved along with the carriage through the radiation beam and radiation measurements are taken. A more detailed description of dynamic phantoms and their applications can be found in U.S. Pat. No. 6,255,622, issued to the instant inventor, the contents of which are incorporated herein in their entirety.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A convertible radiation beam analyzer for measuring the distribution and intensity of radiation produced by a radiation source comprising:
a module including a guideway constructed and arranged to slidably support a carriage for movement along a substantially linear path, said carriage movably secured to said guideway for controlled movement along the length thereof, said module constructed and arranged to be secured to a phantom tank at a first mount position for carriage movement along a vertical axis of said phantom tank, and at a second mount position for carriage movement along a horizontal axis of a phantom tank;
said phantom tank constructed and arranged to contain a material having a density approximating that of a human body, said phantom tank having at least one first mount whereby said module guideway is supported in a substantially vertical orientation and a second mount wherein said module guideway is supported in a substantially horizontal orientation;
at least one radiation detection probe secured to said carriage, said radiation detection probe constructed and arranged to sense photons and electrons, said radiation detection probe being constructed and arranged for electrical connection to an output device for displaying data from said radiation detection probe;
a controller electrically connected to said module for providing electrical signals thereto, whereby said controller is constructed and arranged to instruct a desired direction for movement of said carriage for traversal of said radiation detection probe, whereby movement of said radiation detection probe through a volumetric space within said phantom tank provides data to an output device for determining radiation density and distribution of a radiation beam produced by said radiation source.

2. The convertible radiation beam analyzer of claim 1 wherein said carriage includes a radiation probe beam member, said radiation probe beam member constructed and arranged to extend outwardly from said carriage for extension into a central portion of said phantom tank, said beam member being constructed and arranged for infinite manual positioning of said detection probe along the length thereof, whereby said detection probe is manually secured to said beam member at a predetermined position spaced away from said carriage for movement therewith.

3. The convertible radiation beam analyzer of claim 1 wherein said controller is integrated into said module, wherein said controller is constructed and arranged for electrical connection to a hand pendant, said hand pendant including at least one manually operable member for directing movement of said carriage along said guideway.

4. The convertible radiation beam analyzer of claim 3 wherein manually operable member is a switch.

5. The convertible radiation beam analyzer of claim 1 wherein said controller is integrated into said module, wherein said controller is constructed and arranged for electrical connection to a computer, said computer including software constructed and arranged for electrical communication with said controller for directing movement of said carriage along said guideway throughout a pre-determined path and at a pre-determined traversal rate.

6. The convertible radiation beam analyzer of claim 4 wherein said controller is constructed and arranged for operational control of at least one stepper motor for traversal of said carriage, whereby said computer is constructed and arranged to accept commands from an operator to cause said movement of said carriage throughout said predetermined path.

7. The convertible radiation beam analyzer of claim 5 wherein said computer is constructed and arranged to measure and record the relative position of said carriage as well as the density and distribution of said radiation beam associated with said relative position.

8. The convertible radiation beam analyzer of claim 7 wherein said computer is constructed and arranged to produce a graphical representation of said recorded density and distribution of said radiation beam associated with said relative position.

9. The convertible radiation beam analyzer of claim 1 wherein said phantom tank includes a plurality of side walls secured into a generally rectangular shape having an open upper perimeter, wherein said module guideway includes a first end and a second end, wherein said first end of said guideway is constructed and arranged to cooperate with said upper perimeter defining said first mount position, whereby said guideway is secured in a substantially vertical orientation.

10. The convertible radiation beam analyzer of claim 9 wherein said first end of said guideway includes a U-shaped portion constructed and arranged to cooperate with said upper perimeter.

11. The convertible radiation beam analyzer of claim 10 wherein said U-shaped portion includes at least one thumb screw, positioned to cooperate with a side surface of said phantom tank.

12. The convertible radiation beam analyzer of claim 10 wherein said upper perimeter of said phantom tank includes a vertical member secured thereto and extending upwardly therefrom, wherein said U-shaped portion of said module guideway is constructed and arranged to cooperate with said vertical member to support said module guideway in a substantially horizontal orientation.

13. The convertible radiation beam analyzer of claim 11 wherein said second end of said guideway includes a leveling assembly, wherein said leveling assembly is constructed and arranged to cooperate with said upper perimeter of said phantom tank for manual leveling of said guideway.

14. The convertible radiation beam analyzer of claim 13 wherein said leveling assembly is constructed and arranged for removable attachment to said second end of said guideway, wherein said leveling assembly includes at least one threaded member, wherein said threaded member cooperates with said upper perimeter of said phantom tank, whereby manual rotation of said threaded member causes said second end of said module guideway to move up or down with respect to said upper perimeter of said phantom tank.

15. The convertible radiation beam analyzer of claim 12 wherein said carriage includes an L-shaped member secured thereto, wherein a first leg of said L-shaped member is secured to said carriage so that said L-shaped member extends downwardly and outwardly with respect to said guideway, wherein said radiation detection probe is infinitely securable along a second leg of said L-shaped member so that said probe is extended into a substantially central portion of said phantom tank.

16. The convertible radiation beam analyzer of claim 1 wherein said guideway includes a lead screw rotatably mounted thereon, said lead screw operably connected to said carriage to provide linear motion thereto during rotation of said lead screw, a stepper motor operably connected to said lead screw for electrically controlled bi-directional rotation thereof, said stepper motor in electrical communication with said controller.

17. The convertible radiation beam analyzer of claim 1 wherein said radiation detection probe is an ion chamber.

18. The convertible radiation beam analyzer of claim 1 wherein said radiation detection probe is a diode.

19. The convertible radiation beam analyzer of claim 1 wherein said radiation beam is generated by a linear accelerator.

20. The convertible radiation beam analyzer of claim 1 wherein said radiation beam is generated by a cobalt radiation machine.

21. A kit for converting a single axis radiation beam analyzer into a multi-axis radiation beam analyzer wherein said radiation beam analyzer includes a phantom tank and a guideway for traversing a radiation detector, wherein said guideway is secured to said phantom tank in a vertical orientation for taking depth scans within a radiation field comprising:
a vertical member securable to an upper portion of said phantom tank to extend upwardly with respect to an upper perimeter thereof, wherein said vertical member is constructed and arranged to cooperate with said guideway to support said guideway in a substantially horizontal orientation;
a leveling assembly, wherein said leveling assembly is constructed and arranged to cooperate with said upper perimeter of said phantom tank as well as a distal end of said guideway for support and manual leveling of said guideway, said leveling assembly including at least one threaded member, wherein said threaded member cooperates with said upper perimeter of said phantom tank, whereby manual rotation of said threaded member causes said distal end of said guideway to move up or down with respect to said upper perimeter of said phantom tank;
an L-shaped member for supporting said radiation detector outwardly and downwardly with respect to said guideway, wherein a first leg of said L-shaped member is secured to a traversable portion of said guideway, wherein said radiation detection probe is infinitely securable along a second leg of said L-shaped member so that said probe is extended into a substantially central portion of said phantom tank.
